(19) United States
(12) Patent Application Publication
(10) Pub. No.: US 2018/0140500 A1
(43) Pub. Date: May 24, 2018

(54) BEAUTY DEVICE

(71) Applicant: MTG CO., LTD., Nagoya-shi (JP)

(72) Inventor: Tsuyoshi MATSUSHITA, Nagoya-shi (JP)

(73) Assignee: MTG CO., LTD., Nagoya-shi (JP)

(21) Appl. No.: 15/711,233

(22) Filed: Sep. 21, 2017

(30) Foreign Application Priority Data
Nov. 21, 2016 (JP) 2016-226373

(51) Int. Cl. A61H 15/00

(52) U.S. Cl. CPC A61H 15/0092; A45D 44/22

(57) ABSTRACT

To provide a beauty device capable of being assembled easily and having an excellent outer appearance. A beauty device includes a handle having a handle core portion, and a cylindrical portion which covers one end portion of the handle core portion, a pair of support shafts extended from a side of another end portion of the handle core portion of the handle, and a pair of rotation bodies, each of the rotation bodies being rotatably supported around each of the support shafts. A part of the handle core portion covered by the cylindrical portion is served as a core member of the cylindrical portion inside the cylindrical portion.

### CROSS-REFERENCE TO RELATED APPLICATIONS

This application is based upon and claims the benefit of priority from the prior Japanese Patent Application No. 2016-226373 filed on Nov. 21, 2016, the entire contents of which are incorporated herein by reference.

### BACKGROUND

### 1. Technical Field

The present invention relates to a beauty device.

### 2. Related Art

JP 2013-103085 A discloses a conventional beauty device. The beauty device is provided with a handle and a pair of rotation bodies. The handle is formed in a substantially Y-shape in which a distal end of the handle is bifurcated. The handle is constituted of a base body, a pair of cover bodies which covers an outer circumference of the base body. A ring-like packing is integrated with a whole of an outer peripheral edge of the base body. A pair of the cover bodies is mounted to cover the base body by press-joining an inner peripheral edge of an opening of one cover body to the packing of the base body and by fitting another cover body to an outer peripheral edge of the one cover body. The rotation bodies are formed in a substantially spherical shape and are rotatably supported by a pair of support shafts which are extended so as to spread forward from each distal end of a part where the handle is bifurcated. The beauty device can obtain an excellent outer appearance due to the cover body and can prevent water from entering into an inside of the handle. Further, when the rotation body is rolled on skin, the beauty device can apply a beauty effect such as a massaging effect to the skin.

### SUMMARY

However, the beauty device disclosed in JP 2013-103085 A needs time for press-joining the inner peripheral edge of the opening of the one cover body to the packing of the base body and for fitting the other cover body to the outer peripheral edge of the one cover body, when a pair of the cover bodies is mounted to cover the base body. Further, in the beauty device, since a pair of the cover bodies are attached by fitting with each other, a boundary thereof appears linearly along a direction in which the handle is extended.

The present invention is derived from the problem of the conventional beauty device described above, and an object of the present invention is, in order to solve the problems described above, to provide a beauty device capable of being assembled easily and having an excellent outer appearance.

The beauty device according to the present invention includes:

a handle having a handle core portion and a cylindrical portion which covers one end portion of the handle core portion;

a pair of support shafts extended from another end portion of the handle core portion of the handle; and

a pair of rotation bodies, each of the rotation bodies being rotatably supported around each of the support shafts,

and a part of the handle core portion covered by the cylindrical portion is served as a core member of the cylindrical portion inside the cylindrical portion.

In the beauty device, the handle has the handle core portion and the cylindrical portion, and the cylindrical portion covers one end portion of the handle core. Further, the handle core and the cylindrical portion can be assembled just by inserting the handle core into the cylindrical portion from the one end portion of the handle core. Thus, the beauty device can be assembled easily. Further, the beauty device includes the cylindrical portion formed as a cylindrical body, and thereby an excellent seamless outer appearance can be obtained. Further, in the beauty device, the handle core portion is covered by the cylindrical portion, and thereby the strength thereof can be improved.

Accordingly, the beauty device according to the present invention can be assembled easily and the excellent outer appearance thereof can be obtained.

### BRIEF DESCRIPTION OF DRAWINGS

FIG. 1 is an exploded perspective view illustrating a beauty device according to a first example;

FIG. 2 is a perspective view illustrating a handle core portion, and a support shaft or the like formed in the handle core portion by insert molding according to the first example;

FIG. 3 is a perspective view illustrating the handle core portion to which a sheet metal member is mounted according to the first example;

FIG. 4 is a perspective view of the beauty device seen from a diagonal front side according to the first example;

FIG. 5 is a side view of the beauty device according to the first example;

FIG. 6 is a front view of the beauty device according to the first example;

FIG. 7 is a cross-sectional view taken along line A-A in FIG. 6;

FIG. 8 is an enlarged view of a main part in FIG. 7;

FIG. 9 is a cross-sectional view taken along line B-B in FIG. 6;

FIG. 10 is a cross-sectional view taken along line C-C in FIG. 6;

FIG. 11 is a cross-sectional view taken along line D-D in FIG. 6;

FIG. 12 is a cross-sectional view taken along line E-E in FIG. 6;

FIGS. 13(A) and 13(B) illustrate usage states of the beauty device according to the first example against a face, in which FIG. 13(A) is a view illustrating a rotation body moved back and forth between a chin and an ear and FIG. 13(B) is a view illustrating the rotation body moved back and forth between an end of a lip and a cheekbone; and

FIGS. 14(A) to 14(C) illustrate usage states of the beauty device according to the first example against a hand, in which FIG. 14(A) is a view illustrating the rotation body moved back and forth between a proximal end of a thumb and a fingertip, and FIG. 14(B) is a view illustrating the rotation body moved back and forth in a valley between a thumb and an index finger, and FIG. 14(C) is a view illustrating the rotation body moved back and forth on a side surface portion of a palm at a side of a little finger.

### DETAILED DESCRIPTION

Hereinafter, preferred embodiments according to the present invention are described.

In the beauty device according to the present invention, the handle core portion may include a locking portion, and the cylindrical portion may include a locked portion which prevents the handle core from dropping off by locking with the locking portion of the handle core portion in a state in which the cylindrical portion covers the handle core portion. In this case, in the beauty device, when the handle core is inserted into the cylindrical portion, the handle core is prevented from dropping off from the cylindrical portion. In this way, the beauty device can be assembled easily into a state where the handle core portion is prevented from dropping off from the cylindrical portion.

In the beauty device according to the present invention, the handle core portion may have a power source portion, and the rotation bodies and the cylindrical portion may have conductivity and may be electrically connected to the power source portion. In this case, when a user holds the cylindrical portion of the beauty device to press the rotation body against skin of a face of the like, an electric circuit is formed between the cylindrical portion and the rotation body via a body of the user. Thus, in the beauty device, weak current is supplied to the skin from the rotation body, and thereby the beauty effect such as a massage effect can be enhanced by promotion of stimulation to the skin.

The beauty device according to the present invention may include an exterior member having a drop-off prevention portion locked with the cylindrical portion covering the handle core portion and mounted to a surface of the handle core portion. In this case, in the beauty device, when the handle core portion is inserted into the cylindrical portion, the exterior member is prevented from dropping off from the handle core portion. In this way, the beauty device can be assembled easily into a state where the exterior member is prevented from dropping off from the handle core portion.

Next, a first example embodying the beauty device according to the present invention is described with reference to drawings.

### First Example

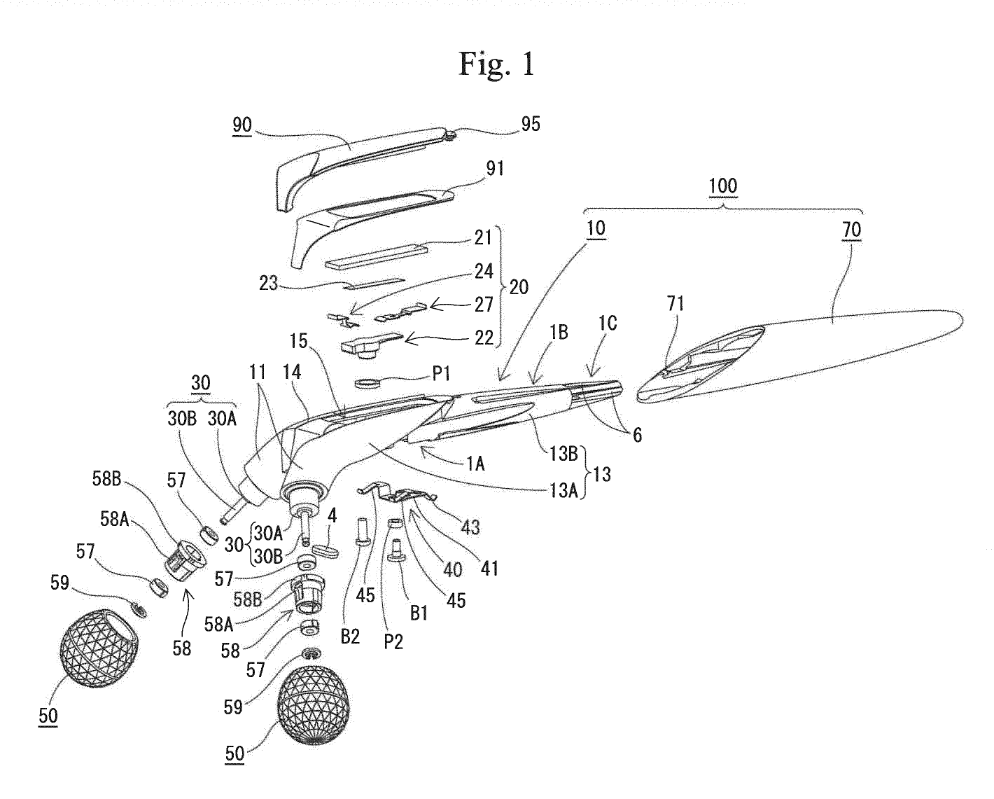

As shown in FIG. 1, a beauty device according to the first example is provided with a handle 100, a pair of support shafts 30, a pair of rotation bodies 50, and a lens cover 90 formed as an exterior member. The handle 100 is provided with a handle core portion 10 and a cylindrical portion 70.

The handle core portion 10 is formed of ABS resin. The handle core portion 10 includes a pair of bifurcated portions 11 bifurcated at one end portion (left side end portion in FIG. 1) (hereinafter, referred to as a front end portion), and a body portion 13 extended linearly from a bifurcation point of the bifurcated portions 11 toward a rear side. Here, regarding a front-rear direction, a side of one end portion (a side where a pair of the bifurcated portions 11 is formed) of the handle core portion 10 is defined as a front side, and a side of another end portion of the handle core portion 10 is defined as the rear side (the same shall apply hereinafter).

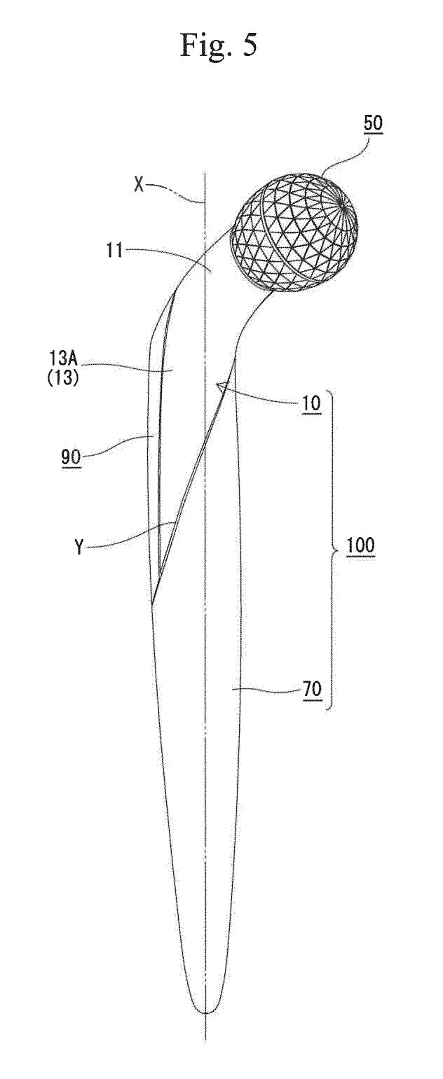

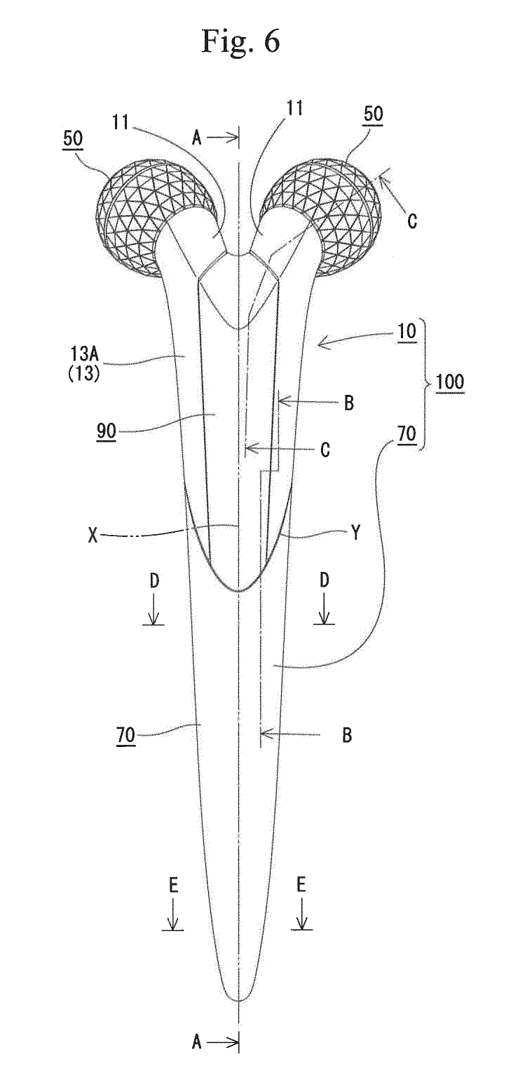

As shown in FIG. 6, when the handle core portion 10 is seen from a front side in a state in which the body portion 13 is extended in a vertical direction with a pair of the bifurcated portions 11 being positioned at an upper side (hereinafter, referred to as a front view), the bifurcated portions 11 are bifurcated toward a left direction and a right direction at the same angle against a center line X extended in a front-rear direction of the body portion 13. Further, as shown in FIG. 5, when the handle core portion 10 is seen from a side in the state where the body portion 13 is extended in a vertical direction with a pair of the bifurcated portions 11 being positioned at an upper side (hereinafter, referred to as a side view), the bifurcated portions 11 are extended to a back surface side (a right side in FIG. 5) so as to be inclined toward a diagonal upper side against the center line X extended in the front-rear direction of the body portion 13 while being curved in the same shape.

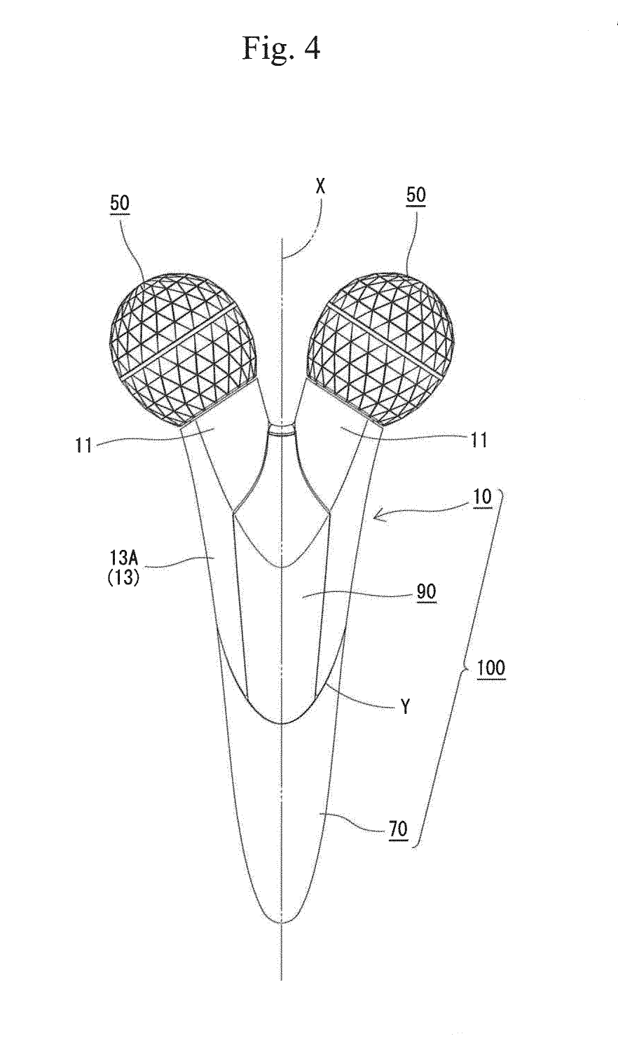

As shown in FIG. 1 to FIG. 3, the body portion 13 is constituted of an exposed portion 13A and an insertion portion 13B. The exposed portion 13A is extended toward the rear side so as to be continued from the bifurcated portions 11. The insertion portion 13B is extended toward the rear side so as to be continued from the exposed portion 13A. The insertion portion 13B is inserted into a cylindrical portion 70 of the handle 100 described below. That is, in the handle core portion 10, the insertion portion 13B of the body portion 13 which is a side of a rear end portion is covered by the cylindrical portion 70. The insertion portion 13B is served as a core member of the cylindrical portion 70 inside the cylindrical portion 70. As shown in FIG. 4 to FIG. 6, a boundary Y which is an rear end edge of the exposed portion 13A and a front end edge of the insertion portion 13B, namely the boundary Y between the exposed portion 13A and the cylindrical portion 70 into which the handle core portion 10 is inserted is formed so as to obliquely go around the outer circumference surface of the handle core portion 10 such that a center portion in a left-right direction on a front surface (a surface at a front side in FIG. 4 and FIG. 6) is located at the rearmost side (a lower side in FIG. 4 to FIG. 6) and a center portion in the left-right direction on a back surface (a surface not shown at a back side in FIG. 4 and FIG. 6) is located at the frontmost side (an upper side in FIG. 5). That is, as shown in FIG. 5, the boundary Y between the exposed portion 13A of the body portion 13 of the handle core portion 10 and the cylindrical portion 70 is inclined linearly toward a diagonal upper side from the front surface to the back surface in the side view.

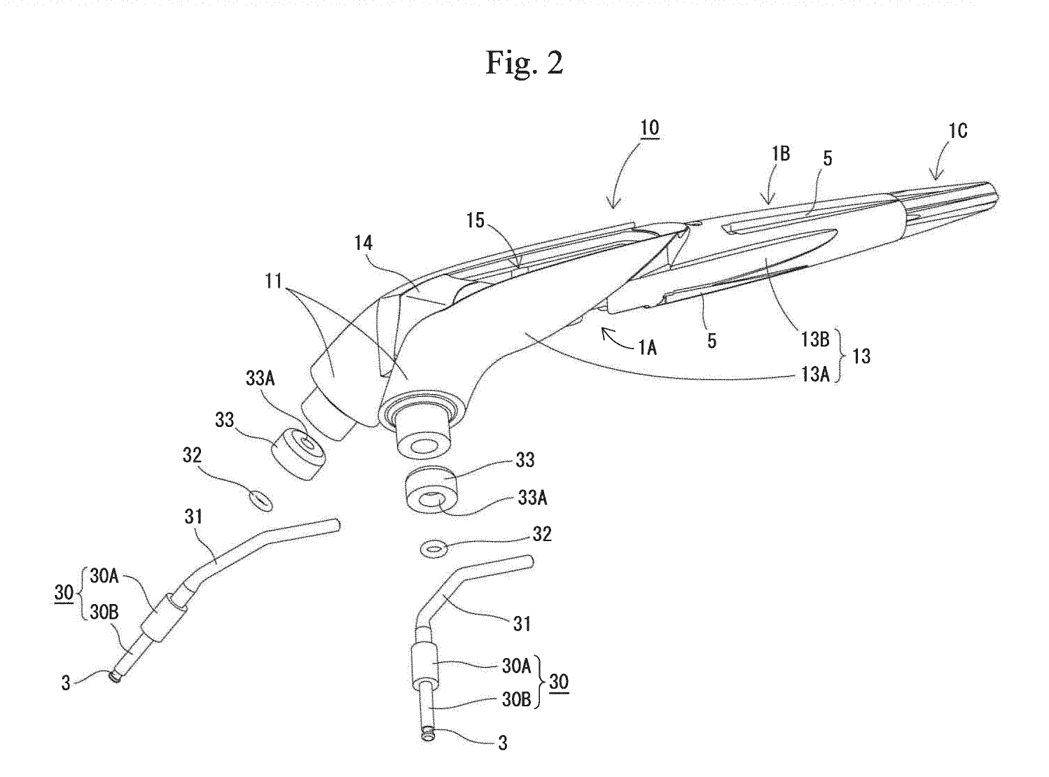

As shown in FIG. 1 and FIG. 2, a recessed portion 14 into which the lens cover 90 is fitted is formed on the handle core portion 10 at a front surface side of the exposed portion 13A. A shape of an opening of the recessed portion 14 is substantially equal to an outer shape of the lens cover 90. A housing portion 15 is formed in the handle core portion 10. The housing portion 15 is opened to the recessed portion 14 of the exposed portion 13A. A shape of an opening of the housing portion 15 is a substantially rectangular shape elongated in the front-rear direction of the handle core portion 10.

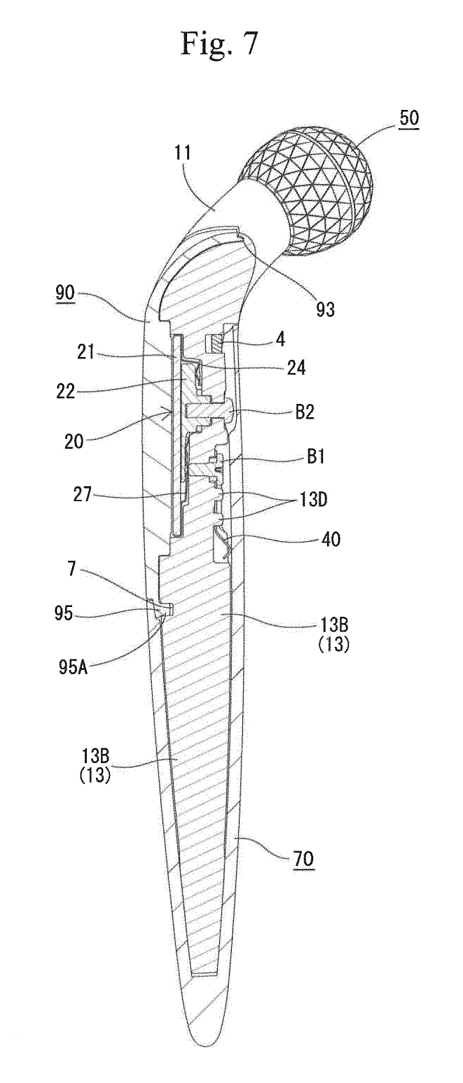

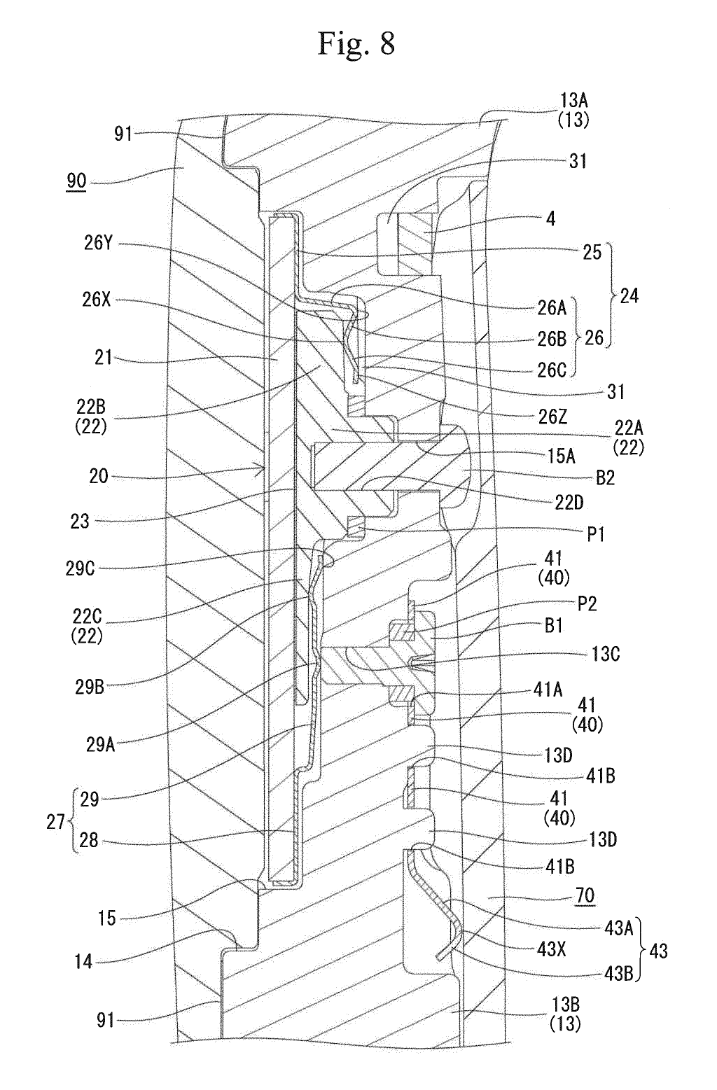

The handle core portion 10 is provided with a power source portion 20. The power source portion 20 is housed in the housing portion 15. As shown in FIG. 1, FIG. 7 and FIG. 8, the power source portion 20 includes a solar power generation panel 21, a terminal pressing member 22, a first terminal 24, and a second terminal 27. The power source portion 20 is mounted to the handle core portion 10 after the solar power generation panel 21, the terminal pressing member 22, the first terminal 24, and the second terminal 27 are assembled together, and therefore assembling of the power source portion 20 is easily performed.

The solar power generation panel 21 is formed in a rectangular and plate shape. As shown in FIG. 8, the terminal pressing member 22 includes a center portion 22A, a front plate portion 22B and a rear plate portion 22C. The center portion 22A is formed in a shape in which two disks having different diameters are overlapped with each other, and an outer diameter at a front surface side (a left surface side in FIG. 8) is set to be large and an outer diameter at a rear surface side is set to be small. The outer diameter of the center portion 22A at the front surface side is slightly larger than a length of a short side of the solar power generation panel 21. A first packing P1 is fitted onto an outer circumference of the center portion 22A at the back surface side having a small outer diameter. Further, a screw hole 22D is formed on the center portion 22A to be opened at a center portion of the back surface of the center portion 22A. The front plate portion 22B is continued to a front side (an upper side in FIG. 8) of the center portion 22A and is formed in a rectangular plate shape. A length of a short side of the front plate portion 22B is slightly smaller than the length of the short side of the solar power generation panel 21. The rear plate portion 22C is continued to a rear side (a lower side in FIG. 8) of the center portion 22A and is formed in a rectangular shape longer than the front plate portion 22B and a plate shape thinner than the front plate portion 22B. A length of a short side of the rear plate portion 22C is equal to the length of the short side of the front plate portion 22B and slightly smaller than the length of the short side of the solar power generation panel 21. The terminal pressing member 22 is adhered on the back surface (a right side surface in FIG. 8) of the solar power generation panel 21 by a double sided tape 23 such that a longitudinal direction in which the front plate portion 22B, the center portion 22A and the rear plate portion 22C of the terminal pressing member 22 are aligned is matched with a longitudinal direction of the solar power generation panel 21.

As shown in FIG. 8, the first terminal 24 includes a first connection portion 25 and a first pressing portion 26. The first connection portion 25 is bent to be contacted with a front end surface (an upper end surface in FIG. 8) of the solar power generation panel 21 and a back surface of the front end portion of the solar power generation panel 21. The first connection portion 25 of the first terminal 24 is electrically connected to the back surface of the front end portion of the solar power generation panel 21. The first pressing portion 26 is constituted of a rising piece 26A, a first inclined piece 26B, and a second inclined piece 26C. The rising piece 26A is continued to a rear end (a lower end in FIG. 8) of the first connection portion 25. The rising piece 26A is extended from the back surface of the solar power generation panel 21 to a position beyond the back surface of the front plate portion 22B, at a front side (an upper side in FIG. 8) with respect to the front plate portion 22B of the terminal pressing member 22. The first inclined piece 26B is continued to a distal end (a right end in FIG. 8) of the rising piece 26A. The first inclined piece 26B is inclined from the distal end of the rising piece 26A toward a rear side (a lower side in FIG. 8) so as to be close to the back surface of the front plate portion 22B. The second inclined piece 26C is continued to a rear end (a lower end in FIG. 8) of the first inclined piece 26B. A boundary 26X between the first inclined piece 26B and the second inclined piece 26C is contacted with the back surface of the front plate portion 22B of the terminal pressing member 22. The second inclined piece 26C is inclined toward the rear side so as to be far away from the back surface of the front plate portion 22B, and a rear end portion 26Z of the second inclined piece 26C is slightly bent toward the back surface side of the front plate portion 22B.

The first terminal 24 is formed of a phosphor bronze plate on which nickel plating is applied. When the power source portion 20 is housed and fixed in the housing portion 15, the first terminal 24 is arranged such that the boundary 26X between the first inclined piece 26B and the second inclined piece 26C is contacted with the back surface of the front plate portion 22B and a boundary 26Y between the rising piece 26A and the first inclined piece 26B and the rear end portion 26Z of the second inclined piece 26C are contacted with an outer surface of a rear end portion of an energizing shaft 31 described below exposed to the housing portion 15. At this time, repulsion force is generated on an elastically deformed part of the first terminal 24, and by the action of the repulsion force, the boundary 26Y between the rising piece 26A and the first inclined piece 26B and the rear end portion 26Z of the second inclined piece 26C can be contacted firmly with the outer surface of the energizing shaft 31 exposed to the housing portion 15. With this, the first terminal 24 and the energizing shaft 31 are electrically connected to each other firmly.

As shown in FIG. 8, the second terminal 27 includes a second connection portion 28 and a second pressing portion 29. The second connection portion 28 is bent to be contacted with a rear end surface (a lower end surface in FIG. 8) of the solar power generation panel 21 and the back surface of the rear end portion of the solar power generation panel 21. The second connection portion 28 of the second terminal 27 is electrically connected to the back surface of the rear end portion of the solar power generation panel 21. The second pressing portion 29 is continued to a front end (an upper end in FIG. 8) of the second connection portion 28. The second pressing portion 29 is separated from the back surface of the rear end portion of the solar power generation panel 21 and extended toward a front side along a back surface of the rear plate portion 22C of the terminal pressing member 22. A convex portion 29A and a concave portion 29B are formed on the second pressing portion 29. When the power source portion 20 is housed and fixed in the housing portion 15, the convex portion 29A is swelled toward a front end surface side of an energizing screw B1 described below which is screwed to the handle core portion 10 and exposed to a bottom surface of the housing portion 15, so as to be contacted with the front end surface of the energizing screw B1. When the power source portion 20 is housed and fixed in the housing portion 15, the concave portion 29B is swelled toward a back surface side of the rear plate portion 22C so as to be contacted with the back surface of the rear plate portion 22C of the terminal pressing member 22 at a front side (an upper side in FIG. 8) with respect to the convex portion 29A.

The second terminal 27 is formed of a phosphor bronze plate on which nickel plating is applied. When the power source portion 20 is housed and fixed in the housing portion 15, the second terminal 27 is arranged such that the convex portion 29A is contacted with the front end surface of the energizing screw B1 and the concave portion 29B is contacted with the back surface of the rear plate portion 22C of the terminal pressing member 22 and a front end 29C of the second pressing portion 29 is contacted with the bottom surface of the housing portion 15. At this time, repulsion force is generated on an elastically deformed part of the second terminal 27, and by the action of the repulsion force, the convex portion 29A can be contacted firmly with the front end surface of the energizing screw B1 exposed to the bottom surface of the housing portion 15. With this, the second terminal 27 and the energizing screw B1 are electrically connected to each other firmly.

A penetration hole 15A is formed on the bottom portion of the housing portion 15 at a position corresponding to a screw hole 22D formed on the center portion 22A of the terminal pressing member 22 in a state in which the power source portion 20 is housed in the housing portion 15. An opening part of the penetration hole 15A on the back surface of the handle core portion 10 is formed on the insertion portion 13B of the body portion 13. Thus, when the handle core portion 10 is inserted into the cylindrical portion 70, the opening part of the penetration hole 15A is covered by the cylindrical portion 70. A fixing screw B2 inserted into the penetration hole 15A from the back surface of the handle core portion 10 is screwed into the screw hole 22D formed on the center portion 22A of the terminal pressing member 22, whereby the power source portion 20 housed in the housing portion 15 is fixed. In this way, when the power source portion 20 is housed and fixed in the housing portion 15, water can be prevented from entering into the housing portion 15 from the penetration hole 15A by the first packing P1 fitted onto the outer circumference of the center portion 22A at a back surface side having a small diameter of the terminal pressing member 22.

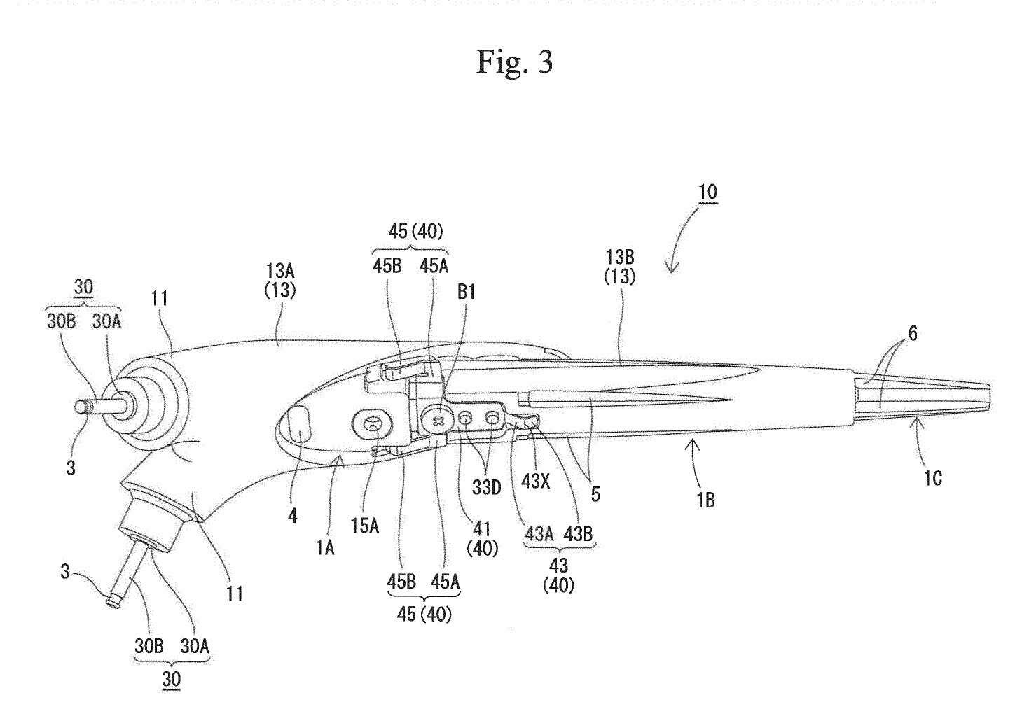

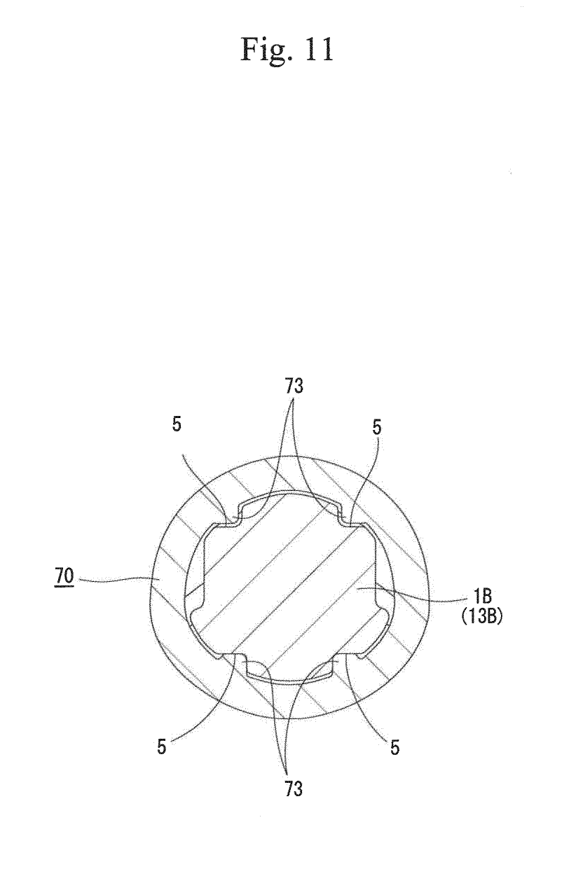

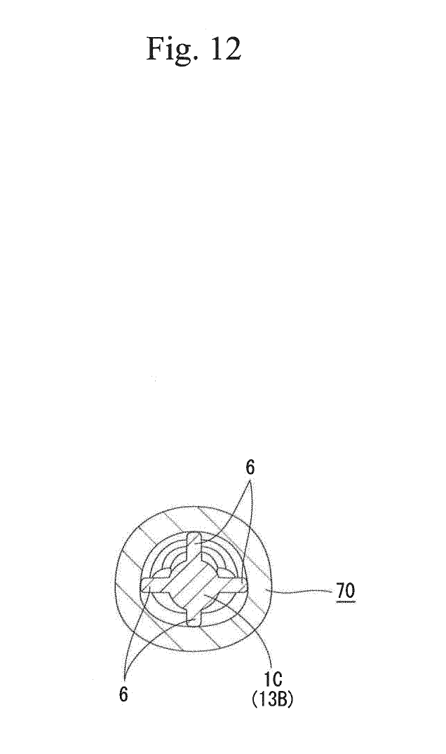

As shown in FIG. 1 to FIG. 3, the insertion portion 13B of the body portion 13 is tapered toward the rear side. The insertion portion 13B is constituted of a front end portion 1A, an intermediate portion 1B, and a rear end portion 1C. As shown in FIG. 3, the front end portion 1A is formed as a part where the exposed portion 13A exists at the front surface side of the body portion 13, and a sheet metal member 40 formed of stainless steel is mounted to a rear surface of the front end portion 1A. As shown in FIG. 11, four grooves 5 extended in the front-rear direction are formed in the intermediate portion 1B. Each of the grooves 5 is formed at a position corresponding to each of four positioning ribs 73 described below which are formed on an inner circumference surface of the cylindrical portion 70 and extended in the front-rear direction. As shown in FIG. 12, four ribs 6 extended in the front-rear direction are formed on an outer circumference surface of the rear end portion 1C. The four ribs 6 are formed at the same intervals in a circumference direction of the outer circumference surface of the rear end portion 1C.

As shown in FIG. 3 and FIG. 8, the sheet metal member 40 mounted to the front end portion 1A of the insertion portion 13B includes a mount portion 41, a contact portion 43, and a pair of locking portions 45.

The mount portion 41 is formed in a substantially rectangular shape elongated in the front-rear direction in a state in which the mount portion 41 is mounted to the front end portion 1A of the insertion portion 13B of the body portion 13. A mount hole 41A and two positioning holes 41B are formed on the mount portion 41 so as to be aligned in the front-rear direction. The mount hole 41A is formed at a front end portion (an upper end portion in FIG. 8) of the mount portion 41. The energizing screw B1 having a second packing P2 fitted onto a shaft portion of the energizing screw B1 is inserted into the mount hole 41A. The sheet metal member 40 is mounted to the front end portion 1A of the insertion portion 13B by screwing the energizing screw B1 into the screw hole 13C formed on the front end portion 1A of the insertion portion 13B. When the sheet metal member 40 is mounted to the front end portion 1A of the insertion portion 13B by screwing the energizing screw B1 into the screw hole 13C, a head portion of the energizing screw B1 is contacted with a back surface of the mount portion 41 of the sheet metal member 40. With this, the energizing screw B1 and the sheet metal member 40 are electrically connected to each other. Further, water is prevented from entering into the housing portion 15 from the screw hole 13C by the second packing P2 fitted onto the shaft portion of the energizing screw B1. The two positioning holes 41B are formed at a rear side of the mount hole 41A. Two bosses 13D aligned in the front-rear direction on the front end portion 1A of the insertion portion 13B so as to be protruded are inserted into the positioning holes 41B, respectively. By inserting the two bosses 13D into the two positioning holes 41B, the sheet metal member 40 can be mounted to the front end portion 1A of the insertion portion 13B in a correct posture.

The contact portion 43 is continued to a rear end (a lower end in FIG. 8) of the mount portion 41. The contact portion 43 includes an inclined piece 43A and a bent piece 43B. The inclined piece 43A is inclined toward a rear outer side. The bent piece 43B is continued to a rear end of the inclined piece 43A and inclined toward a rear inner side. A part near a boundary 43X between the inclined piece 43A and the bent piece 43B is protruded toward an outer side with respect to the back surface of the front end portion 1A of the insertion portion 13B. Thus, when the handle core portion 10 is inserted into the cylindrical portion 70, the boundary 43X between the inclined piece 43A and the bent piece 43B is contacted with the inner circumference surface of the cylindrical portion 70. At this time, repulsion force is generated on an elastically deformed part of the sheet metal member 40 between the mount portion 41 and the contact portion 43, and by the action of the repulsion force, the boundary 43X between the inclined piece 43A and the bent piece 43B can be firmly contacted with the inner circumference surface of the cylindrical portion 70. With this, the sheet metal member 40 and the cylindrical portion 70 on which chrome plating is applied as described below are electrically connected to each other firmly.

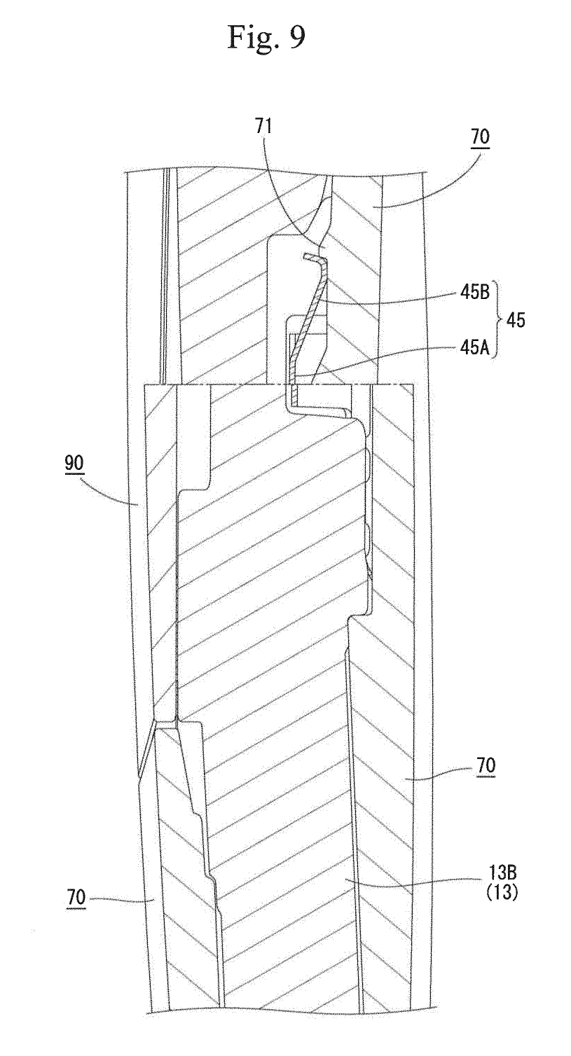

As shown in FIG. 3, each of the locking portions 45 formed as a pair includes a joint portion 45A and a locking portion body 45B. The joint portions 45A are continued to a left end and a right end of the front end portion of the mount portion 41 respectively. The joint portions 45A are bent after being extended from the mount portion 41 toward a front side of the body portion 13 so as to spread toward the left-right direction in a state in which the sheet metal member 40 is mounted to the front end portion 1A of the insertion portion 13B. The locking portion bodies 45B are continued to front ends of parts of the joint portions 45A spread in the left-right direction, respectively. The locking portion bodies 45B are inclined toward a front outer side and each of distal ends of the locking portion bodies 45B is bent into a front inner side. As shown in FIG. 9, when the handle core portion 10 is inserted into the cylindrical portion 70, the distal ends of the locking portion bodies 45B of the pair of the locking portions 45 are respectively locked with a pair of convex portions 71 (locked portion) formed on an inner surface of the cylindrical portion 70. In this way, just by inserting the handle core portion 10 into the cylindrical portion 70, the handle core portion 10 can be prevented from dropping off from the cylindrical portion 70.

As shown in FIG. 1 and FIG. 3, the support shafts 30 formed as a pair are protruded from the distal ends (front end portions of the handle core portion 10) of the bifurcated portions 11 formed as a pair, of the handle core portion 10 respectively, and the support shafts 30 are extended so as to spread. The support shafts 30 formed as a pair are extended to spread with the same angle against the center line X of the handle core portion 10 in the front view. Further, in the front view, the support shafts 30 formed as a pair are extended to spread in the left-right direction with the angle against the center line X of the handle core portion 10 larger than the angle of the bifurcated portions 11 formed as a pair.

As shown in FIG. 1 to FIG. 3, each of the support shafts 30 includes a proximal end portion 30A and a distal end portion 30B. The proximal end portion 30A is formed in a columnar shape. The distal end portion 30B is formed in a columnar shape having a diameter smaller than a diameter of the proximal end portion 30A. The distal end portion 30B is arranged coaxially with the proximal end portion 30A and is extended to be continued to a distal end side of the proximal end portion 30A. The distal end portion 30B has a distal end formed with a groove portion 3 which goes around in the circumference direction so as to be fitted with a pressuring C-ring 59 described below. In each of the support shafts 30, the energizing shaft 31 formed in a columnar shape having an outer diameter substantially same as a diameter of the distal end portion 30B is integrally formed to be continued to a rear end of the proximal end portion 30A. Each of the energizing shafts 31 is bent at two points in each of intermediate portions. Each of the support shafts 30 and each of the energizing shafts 31 are formed of stainless steel.

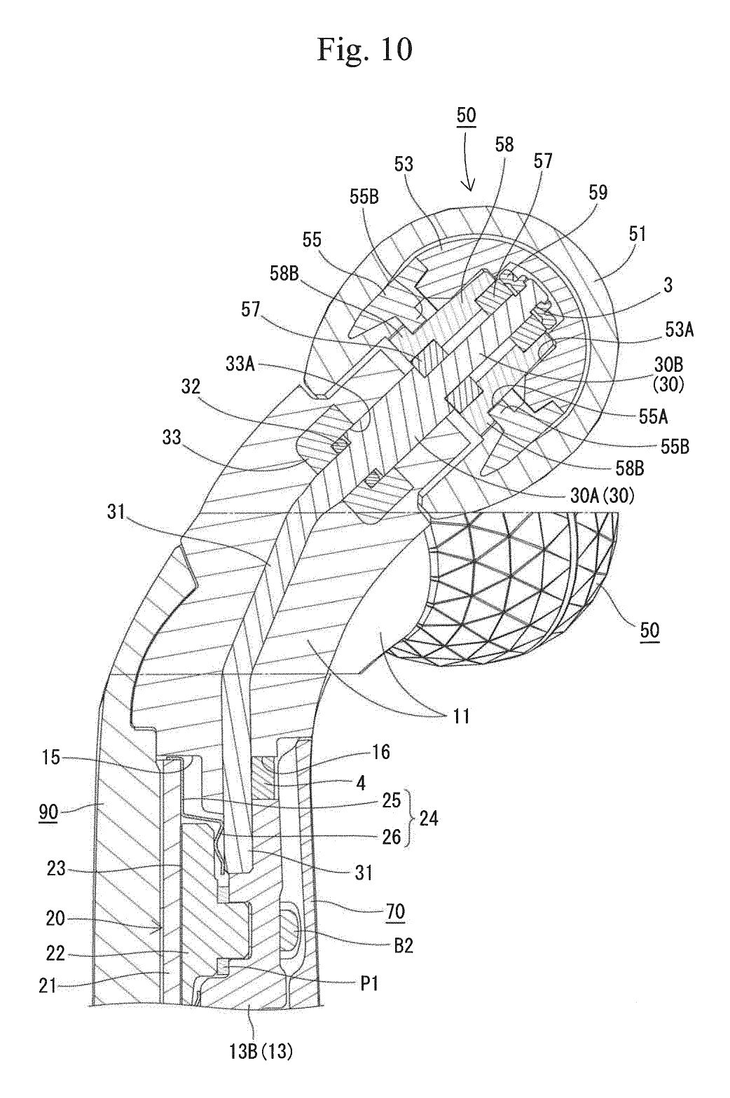

As shown in FIG. 10, each of the energizing shafts 31 is inserted into an O-ring 32 formed of nitrile rubber. Further, each of the energizing shafts 31 is inserted into an O-ring cover 33 formed of ABS resin. As shown in FIG. 2 and FIG. 10, each of the O-ring cover 33 is formed in a cylindrical shape, and an inner diameter of a penetration hole 33A is changed in two steps. That is, as shown in FIG. 10, each of the O-ring cover 33 is formed such that an inner diameter at a distal end side of the penetration hole 33A is slightly larger than an outer diameter of the proximal end portion 30A of the support shaft 30, and the part of the penetration hole 33A houses the O-ring 32 and a part of the proximal end portion 30A of the support shaft 30. Further, each of the O-ring cover 33 is formed such that an inner diameter at a rear end side of the penetration hole 33A is slightly larger than an outer shape of the energizing shaft 31, and thereby the energizing shaft 31 is inserted into the O-ring cover 33.

The support shaft 30, the energizing shaft 31, the O-ring 32, and the O-ring cover 33 are formed such that the energizing shaft 31 is inserted into the O-ring cover 33 in a state in which the energizing shaft 31 is inserted into the O-ring 32 and then a part of the proximal end portion 30A of the support shaft 30 is housed in a distal end portion of the penetration hole 33A of the O-ring cover 33. Thereupon, the O-ring 32 is housed in a space formed by the proximal end portion 30A of the support shaft 30 and the penetration hole 33A at the distal end side of the O-ring cover 33. In this state, as shown in FIG. 10, the support shaft 30, the energizing shaft 31, the O-ring 32, and the O-ring cover 33 are arranged in a molding die which forms the handle core portion 10 such that a distal end portion of the proximal end portion 30A of the support shaft 30 is exposed to a distal end surface of the bifurcated portion 11 of the handle core portion 10, and a part of the outer surface of the rear end portion of the energizing shaft 31 is exposed in the housing portion 15 formed in the exposed portion 13A of the handle core portion 10, and then the handle core portion 10 is formed by injecting the ABS resin into the molding die. That is, the support shaft 30, the energizing shaft 31, the O-ring 32, and the O-ring cover 33 are integrally formed in the handle core portion 10 by means of injection molding. The O-ring 32 into which the energizing shaft 31 is inserted can prevent water from entering into the housing portion 15 from the distal end surface of the bifurcated portion 11 of the handle core portion 10 in which the proximal end portion 30A of the support shaft 30 is exposed, along the outer circumference surfaces of the support shaft 30 and the energizing shaft 31. Further, by fitting a waterproof plug 4 formed of silicon rubber into a recessed portion 16 to which the outer surface of the rear end portion of the energizing shaft 31 is exposed, the recessed portion 16 being formed for insert molding the support shaft 30, the energizing shaft 31, the O-ring 32, and the O-ring cover 33, water is prevented from entering into the housing portion 15 from the recessed portion 16 along the outer circumference surface of the energizing shaft 31.

As shown in FIG. 10, each of the rotation bodies 50 is provided with an outer shell portion 51, an upper core portion 53, and a lower core portion 55. The outer shell portion 51 is formed as a hollow body having an outer shape of a substantially spherical shape. The outer shell portion 51 is formed with an opening into which the distal end portion 30B and the support shaft 30 of the handle core portion 10 are inserted. The outer shell portion 51 is formed of ABS resin, and platinum plating is applied on a whole of a front surface and a back surface of the outer shell portion 51. A diamond cut is applied to an outer circumference surface of the outer shell portion 51. The upper core portion 53 is housed in the outer shell portion 51 at a front end side thereof and the lower core portion 55 is housed in the outer shell portion 51 such that a front end surface of the lower core portion 55 is contacted with a rear end surface of the upper core portion 53. A recessed portion 53A which houses a distal end portion of a bearing holder 58 described below is formed on the upper core portion 53. The lower core portion 55A is formed with a penetration hole 55A into which the bearing holder 58 is inserted. The lower core portion 55A is provided with a locking portion 55B protruded from an inner circumference surface of the penetration hole 55A to an inside. A claw portion 58A formed on an outer circumference surface of the bearing holder 58 is locked with a front surface of the locking portion 55B of the lower core portion 55, and a flange portion 58B formed at a rear end portion of the bearing holder 58 is locked with a rear surface of the locking portion 55B of the lower core portion 55. A surface of the rear end portion of the lower core portion 55 is contacted with a back surface of the outer shell portion 51. Each of the upper core portion 53 and the lower core portion 55 is formed of ABS resin, and platinum plating is applied to a whole of the surface thereof. In this way, each of the outer shell portion 51, the upper core portion 53, and the lower core portion 55 is subjected to the platinum plating, and the outer shell portion 51 and the lower core portion 55 are contacted with each other, and the lower core portion 55 and the upper core portion 53 are contacted with each other, with the result that the outer shell portion 51, the upper core portion 53 and the lower core portion 55 are electrically connected to each other.

As shown in FIG. 1 and FIG. 10, each of the rotation bodies 50 is rotatably supported by the support shaft 30 via the bearing holder 58 into which a pair of bearings 57 is embedded. The bearing holder 58 is formed in a substantially cylindrical shape. The bearing holder 58 is provided with a pair of the claw portions 58A protruded from the outer circumference surface of the bearing holder 58. The claw portions 58A are formed on the outer circumference surface of the bearing holder 58 so as to make an angle therebetween of 180 degrees. The bearing holder 58 is provided with the flange portion 58B extended from an outer peripheral edge of the rear end portion toward an outside.

The bearings 57 formed as a pair are embedded in a front end portion and a rear end portion of the bearing holder 58. The bearings 57 are embedded coaxially in the bearing holder 58. The distal end portion 30B of the support shaft 30 is inserted into the bearing holder 58 and a distal end of the support shaft 30 is protruded from a front end surface of the bearing holder 58. The preloading C-ring 59 is fitted with the groove portion 3 formed at the distal end of the support shaft 30 protruded from the front end surface of the bearing holder 58, and the bearing holder 58 is rotatably mounted to the support shaft 30. Each of the bearing holder 58 and the bearing 57 is formed of polyacetal resin having conductivity. Thus, the bearing holder 58 and the bearing 57 are electrically connected to each other. Further, since the bearing 57 is contacted with the outer circumference surface of the support shaft 30, the bearing holder 58, the bearing 57 and the support shaft 30 are electrically connected to each other. The preloading C-ring 59 is formed of polyacetal resin.

The support shaft 30 to which the bearing holder 58 is rotatably mounted is inserted into the rotation body 50 from an opening of the outer shell portion 51. Thereupon, a pair of the claw portions 58A protruded from the outer circumference surface of the bearing holder 58 is pressed into the bearing holder 58 when passing the locking portion 55B of the lower core portion 55, and after passing the locking portion 55B of the lower core portion 55, a pair of the claw portions 58A is protruded from the outer circumference surface of the bearing holder 58, and thereby a pair of the claw portions 58A is locked with the front surface of the locking portion 55B of the lower core portion 55. Further, the claw portion 58A of the bearing holder 58 is locked with the front surface of the locking portion 55B of the lower core portion 55 and the flange portion 58B of the bearing holder 58 is locked with the rear surface of the locking portion 55B of the lower core portion 55. In this way, a pair of the rotation bodies 50 is rotatably supported together with the bearing holders 58 by a pair of the support shafts 30. In this state, the upper core portion 53 and the lower core portion 55 of the rotation body 50 are contacted with the outer circumference surface of the bearing holder 58. With this, the bearing holder 58 and the rotation body 50 are electrically connected to each other. In this way, in the beauty device, the solar power generation panel 21, the first terminal 24, the energizing shaft 31, the support shaft 30, the bearing 57, the bearing holder 58, and the rotation body 50 are electrically connected to each other.

As shown in FIG. 1, the cylindrical portion 70 is formed in a cylindrical shape in which the front end side is opened and the body is tapered toward the rear side and the rear end portion is closed with a round shape. The insertion portion 13B of the body portion 13 of the handle core portion 10 covered by the cylindrical portion 70 occupies substantially the whole of an inner space of the cylindrical portion 70. The insertion portion 13B is served as a core member of the cylindrical portion 70 and thereby the strength of the cylindrical portion 70 is improved. The front end portion of the cylindrical portion 70 is inclined such that a center portion in the left-right direction of the back surface is located at the frontmost side (an upper side in the side view of FIG. 5) and a center portion in the left-right direction of the front surface is located at the rearmost side (a lower side in the side view of FIG. 5). As shown in FIG. 1 and FIG. 9, the cylindrical portion 70 has two points on the front end portion thereof which are formed with a pair of protrusions 71 (locked portion) with which the pair of the locking portions 45 of the sheet metal member 40 are locked respectively when the handle core portion 10 is inserted into the cylindrical portion 70. With this, in the beauty device, when the insertion portion 13B of the body portion 13 of the handle core portion 10 is inserted into the cylindrical portion 70, the handle core portion 10 is prevented from dropping off from the cylindrical portion 70. In this way, in the beauty device, the handle core portion 10 and the cylindrical portion 70 can be assembled easily into a state in which the handle core portion 10 is prevented from dropping off from the cylindrical portion 70. The cylindrical portion 70 is fixed to the handle core portion 10 by an adhesive coated around a part to which the head portion of the fixing screw B2, which fixes the power source portion 20 to the handle core portion 10, is exposed on the back surface of the insertion portion 13B of the body portion 13 of the handle core portion 10.

As shown in FIG. 11, four positioning ribs 73, which are extended in the front-rear direction, are formed on the inner circumference surface of a part of the cylindrical portion 70 into which the insertion portion 13B of the body portion 13 of the handle core portion 10 is inserted. The insertion portion 13B of the body portion 13 of the handle core portion 10 is inserted into the cylindrical portion 70 while the four positioning ribs 73 are fitting with the grooves 5 formed on the intermediate portion 1B of the insertion portion 13B of the body portion 13 of the handle core portion 10. With this, the cylindrical portion 70 is mounted such that an opening edge of the front end portion is contacted with a rear end edge of the exposed portion 13A of the body portion 13 of the handle core portion 10 without a gap. Further, when the handle core portion 10 is inserted into the cylindrical portion 70, as shown in FIG. 12, each of outer side surfaces of the four ribs 6 formed on the rear end portion 3C of the insertion portion 13B of the body portion 13 of the handle core portion 10 is contacted with the inner circumference surface of the cylindrical portion 70. With this, the handle core portion 10 can be fixed in the cylindrical portion 70 firmly.

The cylindrical portion 70 is formed of ABS resin, and chrome plating is applied to the whole of the outer circumference surface and a front side of the inner circumference surface (at least a portion from the opening edge of the front end portion to a rear side of a part with which the boundary 43X between the inclined piece 43A and the bent piece 43B of the contact portion 43 of the sheet metal member 40 is contacted in a state in which the cylindrical portion 70 is mounted to the handle core portion 10). With this, when the handle core portion 10 is inserted into the cylindrical portion 70, the sheet metal member 40 and the cylindrical portion 70 are electrically connected to each other. In this way, in the beauty device, the solar power generation panel 21, the second terminal 27, the energizing screw B1, the sheet metal member 40 and the cylindrical portion 70 are electrically connected to each other.

As shown in FIG. 1, and FIG. 4 to FIG. 6, the lens cover 90 is fitted with the recessed portion 14 formed on the front surface of the exposed portion 13A such that the housing portion 15 opened to the front surface of the exposed portion 13A of the body portion 13 of the handle core portion 10 is covered by the lens cover 90, and then the lens cover 90 is mounted to the center portion in the left-right direction of the front surface of the exposed portion 13A. The lens cover 90 is elongated in the front-rear direction, and the front end portion thereof is extended to enter into a space between the bifurcated portions 11 of the handle core portion 10, and a surface of the rear end portion thereof is contacted with the front end edge of the front surface of the cylindrical portion 70. The lens cover 90 is formed such that a part of the lens cover 90 overlapped with the solar power generation panel 21 is formed in a rectangular shape elongated in the front-rear direction and formed to be transparent. The lens cover 90 is formed of acryl resin. The lens cover 90 is adhered to the handle core portion 10 by a double sided tape 91 in which an outer shape is substantially the same as an outer shape of the lens cover 90 and a part overlapped with the solar power generation panel 21 is removed.

As shown in FIG. 7, in the lens cover 90, a locking convex portion 93 in which a back surface side thereof is protruded with respect to a front surface side thereof is formed on the front end portion of the center portion in the left-right direction of the lens cover 90. The locking convex portion 93 is locked with a concave portion formed between the bifurcated portions 11 of the handle core portion 10. Further, in the lens cover 90, a drop-off prevention portion 95 overlapped and locked with a lower portion of the front end portion of the cylindrical portion 70 mounted to the handle core portion 10 is formed on the rear end portion of the center portion in the left-right direction of the lens cover 90. In the drop-off prevention portion 95, a convex portion 95A fitted with a concave portion 7 formed on the insertion portion 13B of the body portion 13 of the handle core portion 10 is formed on the rear end portion of the drop-off prevention portion 95.

In the beauty device having such a configuration, after the power source portion 20, the lens cover 90, and the sheet metal member 40 are mounted to the handle core portion 10, the handle core portion 10 and the cylindrical portion are assembled by inserting the handle core portion 10 into the cylindrical portion 70 from the rear end portion of the handle core portion 10. In this way, in the beauty device, the handle core portion 10 and the cylindrical portion 70 can be assembled easily. Further, since the beauty device is provided with the cylindrical portion 70 formed in a cylindrical shape, an excellent seamless outer appearance can be obtained. Further, in the beauty device, a part of the handle core portion 10 is covered by the cylindrical portion 70 into which the handle core portion 10 is inserted, and thereby the strength thereof can be improved.

Accordingly, the beauty device according to the first example can be assembled easily and the excellent outer appearance thereof can be obtained.

Further, in the beauty device, when the handle core portion 10 is inserted into the cylindrical portion 70, a pair of the locking portions 45 formed on the sheet metal member 40 mounted to the handle core portion 10 is locked with a pair of the concave portions 71 formed on the inner surface of the cylindrical portion 70. With this, the handle core portion 10 is prevented from dropping off from the cylindrical portion 70. Further, the drop-off prevention portion 95 formed on the rear end portion of the lens cover 90 is overlapped with the lower side of the front end portion of the cylindrical portion 70. With this, in the beauty device, the lens cover 90 is prevented from dropping off from the handle core portion 10. In this way, the beauty device can be assembled easily into a state in which the handle core portion 10 is prevented from dropping off from the cylindrical portion 70 and the lens cover 90 is prevented from dropping off from the handle core portion 10.

Further, in the beauty device, after the bearing holder 58 into which a pair of the bearings 57 is embedded is rotatably mounted to a pair of the support shafts 30, each of the support shafts 30 to which the bearing holder 58 is mounted is inserted and pressed into each of the rotation bodies 50 from the opening of the outer shell portion 51. Thereupon, the claw portion 58A of each of the bearing holders 58 is locked with the locking portion 55B of the lower core portion 55 of each of the rotation bodies 50, and thereby each of the rotation bodies 50 is rotatably supported together with the bearing holder 58 around each of the support shafts 30.

Further, in the handle core portion 10, the insertion portion 13B of the body portion 13 is inserted into the cylindrical portion 70 to occupy substantially the whole of the inner space of the cylindrical portion 70. With this, the insertion portion 13B is served as a core member of the cylindrical portion 70 formed in a cylindrical shape. Thus, the strength of the handle 100 can be improved. Further, the gravity center can be located at a side of the cylindrical portion formed as a part to be held and thereby the cylindrical portion can be held easily as compared to a configuration in which the handle core portion 10 is not inserted deeply and thereby a hollow space is formed in the cylindrical portion 70. As a result, usability of the beauty device can be improved.

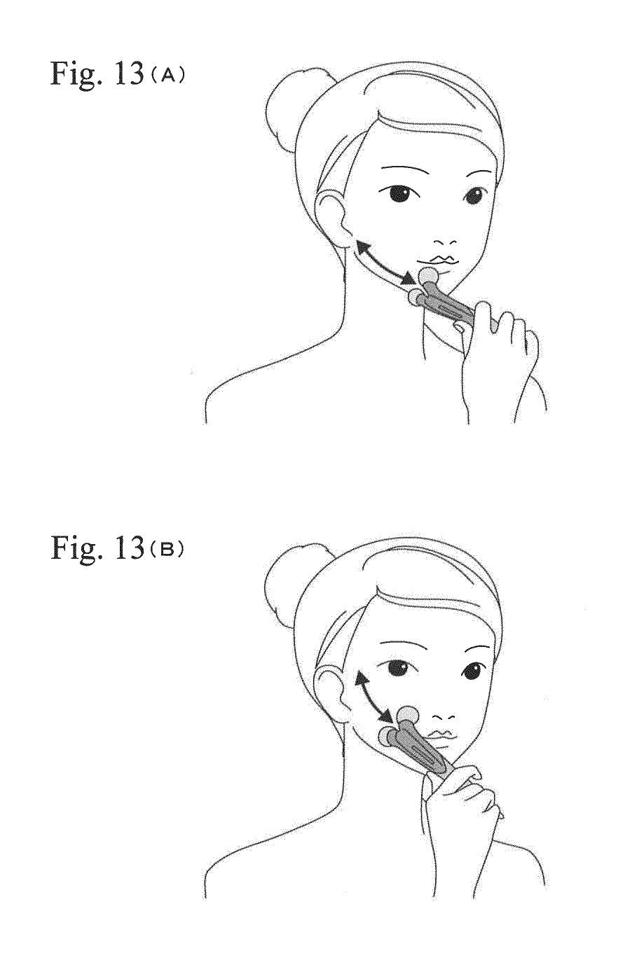

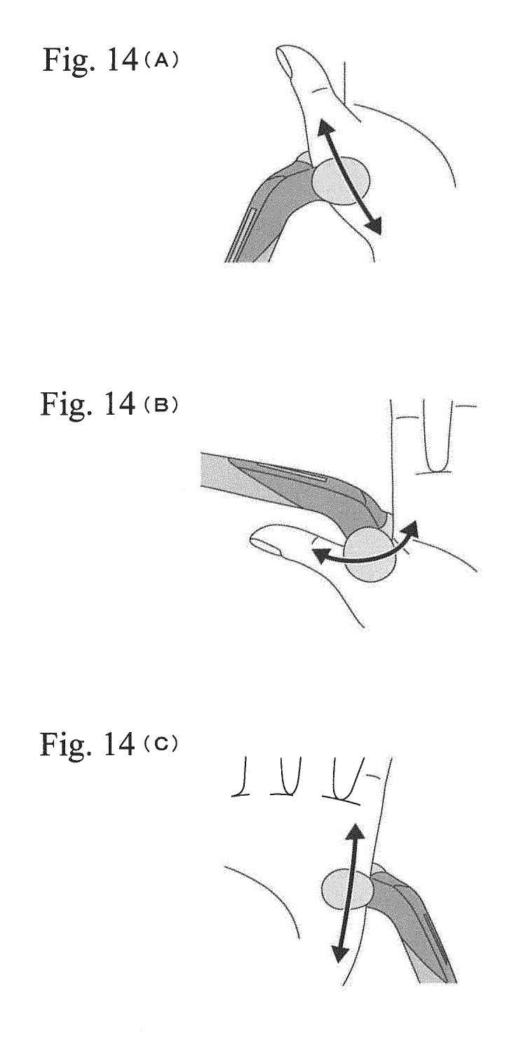

The beauty device assembled in this way can be used by holding the cylindrical portion 70 of the handle 100 while the rotation body 50 is rotated so as to be moved back and forth on an arbitrary portion of a face such as a portion between an end of a lip and a cheekbone as shown in FIGS. 13(A) and 13(B). Further, the beauty device can be used by holding the cylindrical portion 70 while the rotation body 50 is rotated so as to be moved back and forth on an arbitrary portion of a hand such as a portion between a proximal end of a thumb and a fingertip, a valley between a thumb and an index finger, and a side surface portion of a palm at a side of a little finger as shown in FIGS. 14 (A) to 14(C).

In the beauty device, one electrode of the solar power generation panel 21, the first terminal 24, the energizing shaft 31, the support shaft 30, the bearing 57, the bearing holder 58 and a pair of the rotation bodies 50 are electrically connected to each other, and another electrode of the solar power generation panel 21, the second terminal 27, the energizing screw B1, the sheet metal member 40, and the cylindrical portion 70 are electrically connected to each other. With this, when the beauty device is used as described above, an electric circuit is formed between the cylindrical portion 70 and the rotation body 50 via a body of the user and weak current is supplied to skin from the rotation body 50, and thereby a beauty effect such as a massaging effect can be further enhanced by promoting stimulation to the skin.

The present invention is not limited to the first example described above with reference to the drawings, and for example, the following examples are encompassed by the scope of the present invention.

(1) In the first example, the locking portion is formed on the sheet metal member mounted to the handle core portion and the locked member locked with the locking portion is formed on the cylindrical portion, however the locking portion and the locked portion may not be formed.

(2) In the first example, the locking portion locked with the locked portion of the cylindrical portion is formed on the sheet metal member, however a locking portion may be formed on the handle core portion separately from the sheet metal member.

(3) In the first example, the handle core portion is provided with the power source portion, however the handle core portion may not be provided with the power source portion. In this case, it is not necessary that the cylindrical portion and a pair of the rotation bodies have conductivity and are electrically connected to the power source portion.

(4) In the first example, the exterior member is the lens cover, however the exterior member may be another exterior member as long as it is mounted to the surface of the handle core portion.

(5) In the first example, the lens cover is provided with the drop-off prevention portion, however the lens cover may not be provided with the drop-off prevention portion.

(6) In the first example, two rotation bodies are rotatably supported by the support shafts formed as a pair and extended to spread in the front end portion of the handle core portion, however the support shafts extended to spread in the front end portion of the handle core portion may be formed to make more than two pairs, and the rotation body may be rotatably supported by each of the support shafts.

(7) Other material may be adopted instead of the material of each component described in the first example.

(8) In the first example, a configuration in which the adhesive is coated around a part to which the head portion of the fixing screw fixed to the handle core portion is exposed is described as an example, however a configuration in which the adhesive is coated on the whole of the insertion portion of the handle core portion may be adopted. In this case, the cylindrical portion and the handle core portion can be fixed to each other more firmly. Further, the adhesive is filled in a gap between the cylindrical portion and the handle core portion and therefore the weight is increased by an amount of the adhesive, so that the gravity center of the beauty device can be located at a side of the cylindrical portion formed as a part to be held, and the cylindrical portion can be held easily. As a result, usability of the beauty device can be improved.

(9) In the first example, a configuration in which the insertion portion of the body portion of the handle core portion is inserted into the cylindrical portion to occupy substantially the whole of the inner space of the cylindrical portion is described as an example, however it is not limited to this. The handle core portion may only have to be inserted into the cylindrical portion such that a length of the handle core portion served as the core member of the cylindrical portion. It is preferable that the handle core portion is inserted into more than a half of the cylindrical portion. That is, in order to form the handle core portion served as the core member of the cylindrical portion, it is preferable that the handle core portion is inserted into the cylindrical portion by a length of more than a half length of the cylindrical portion in the longitudinal direction. In this case, when force to bend the handle is applied, the handle core portion can be served as the core member without being bent or dropped off from the cylindrical portion, and thereby the strength of the cylindrical portion can be improved.

1. A beauty device comprising:
a handle having a handle core portion and a cylindrical portion which covers one end portion of the handle core portion;
a pair of support shafts extended from another end portion of the handle core portion of the handle; and
a pair of rotation bodies, each of the rotation bodies being rotatably supported around each of the support shafts,
wherein a part of the handle core portion covered by the cylindrical portion is served as a core member of the cylindrical portion inside the cylindrical portion.

2. The beauty device according to claim 1, wherein the handle core portion includes a locking portion, and
the cylindrical portion includes a locked portion which prevents the handle core from dropping off by locking with the locking portion of the handle core portion in a state in which the cylindrical portion covers the handle core portion.

3. The beauty device according to claim 1, wherein the handle core portion includes a power source portion, and
the rotation bodies and the cylindrical portion have conductivity and are electrically connected to the power source portion.

4. The beauty device according to claim 2, wherein the handle core portion includes a power source portion, and
the rotation bodies and the cylindrical portion have conductivity and are electrically connected to the power source portion.

5. The beauty device according to claim 1, further comprising, an exterior member having a drop-off prevention portion locked with the cylindrical portion covering the handle core portion and mounted to a surface of the handle core portion.

6. The beauty device according to claim 2, further comprising, an exterior member having a drop-off prevention portion locked with the cylindrical portion covering the handle core portion and mounted to a surface of the handle core portion.

7. The beauty device according to claim 3, further comprising, an exterior member having a drop-off prevention portion locked with the cylindrical portion covering the handle core portion and mounted to a surface of the handle core portion.

8. The beauty device according to claim 4, further comprising, an exterior member having a drop-off prevention portion locked with the cylindrical portion covering the handle core portion and mounted to a surface of the handle core portion.
